(19) United States
(12) Patent Application Publication
(10) Pub. No.: US 2005/0268285 A1
(43) Pub. Date: Dec. 1, 2005

(54) Object oriented GUI test automation

(75) Inventors: Elizabeth V. Bagley, Cedar Park, TX (US); Christina R. Carlson, Chanhassen, MN (US); James L. Jones, Round Rock, TX (US); Karen A. Rosengren, Round Rock, TX (US)

Correspondence Address: CHRISTOPHER & WEISBERG, PA, 200 E. LAS OLAS BLVD, SUITE 2040, FT LAUDERDALE, FL, 33301, US

(73) Assignee: International Business Machines Corporation, Armonk, NY (US)

(21) Appl. No.: 10/852,908

(22) Filed: May 25, 2004

(51) Int. Cl. G06F 9/44

(52) U.S. Cl. 717/124

(57) ABSTRACT

A method, system and apparatus for the object-oriented automated user interface testing of an application under test in a functional testing tool. The functional testing tool can include a configuration for producing multiple methods defining interactions with individual elements in a user interface to an application under test. The functional testing tool further can include one or more defined actions grouping selected ones of the methods which are used repeatedly within screens of the application under test. Preferably, at least one task defining a group of related activities in the user interface can be produced in the functional testing tool. Subsequently, a test case can be generated which implements the task with at least one verification point.

### BACKGROUND OF THE INVENTION

1. Statement of the Technical Field

The present invention relates to software testing, and more particularly to the automated testing of a user interface for a software application.

2. Description of the Related Art

Software functional testing relates to the functional testing of a user interface (UI) coupled to an underlying software application. Conventional functional testing tools allow the end user to create, modify and run functional, distributed functional, regression and smoke tests for applications built using any of a wide variety of integrated development environments. In operation, the conventional functional testing tool can generate a test script for a UI in which elements of the UI can be exercised both sequentially and conditionally. Through a thorough testing of the UI of an application, the functional testing tool can automatically identify defects early, often and repeatably.

Generally speaking, the conventional functional testing tool can monitor and record the interaction between end user and UI during a recording phase of functional testing. In this regard, a testing script can be produced based upon the identity of UI elements addressed by the end user and the sequence in which the UI elements are addressed. Within the script, UI elements, referred to often as “objects”, can be identified by absolute reference to each object. Using the testing script, the interaction between end user and UI can be repeated automatically without requiring additional intervention on the part of the end user.

In accordance with the conventional functional testing approach, one must consider every possible series of actions that might be required for testing an application. For each considered series of actions, the actions must be recorded to effectively cover every possible test case. Given the complexity of computer software today, however, recording an exhaustive set of series of actions for the different test cases can be substantially time consuming. Furthermore, maintaining a multiplicity of test cases can incur high maintenance costs because all of the previously recorded scripts can change whenever a developer performs a change in the application user interface.

To address the deficiencies of the conventional functional testing approach, the IBM Rational® XDE™ Tester functional testing product provides an alternative, object-oriented approach which departs from the standard referencing of mere interface objects without providing the requisite elements of true object orientation: inheritance, extensibility, encapsulation and polymorphism. As a plain example, conventional software functional testing tools permit referencing a user interface button as an object in a Web page, yet a button class cannot be created to refer to a user interface button rendered in a Web page.

In any event, though the IBM Rational XDE Tester overcomes many of the problems inherent to the record-playback methodology of conventional software functional testing tools, several problems remain. Specifically, a lack of a standardized process for creating, naming and organizing the implementation of objects, actions taken on objects, common tasks and test cases has resulted in a reduction in the interoperability of solutions created by different testing teams. Moreover, the lack of a standardized approach further has reduced the reusability of test artifacts across testing teams and has increased the maintenance costs for test automation.

### SUMMARY OF THE INVENTION

The present invention addresses the deficiencies of the art in respect to automated testing of a user interface to an application under test and provides a novel and non-obvious method, system and apparatus for the object-oriented automated user interface testing of an application under test in a functional testing tool. The functional testing tool can include a configuration for producing multiple methods defining interactions with individual elements in a user interface to an application under test. The functional testing tool further can include one or more defined actions grouping selected ones of the methods which are used repeatedly within screens of the application under test.

Preferably, at least one task defining a group of related activities in the user interface can be produced in the functional testing tool. Subsequently, a test case can be generated which implements the task with at least one verification point. In a preferred aspect of the invention, the functional testing tool can include a super helper class from which the test case can be derived. Additionally, the methods can include individual methods directed to interactions with specific user interface elements; and, abstracted methods directed to generalized interactions with comparable user interface elements. In this regard, the abstracted methods can be disposed within a super helper class from which the test case is derived.

A method for generating an object oriented test script in a functional testing tool can include coding multiple methods specifying interactions with individual elements in a user interface to an application under test and grouping selected ones of the methods which are used repeatedly within screens of the application under test into one or more defined actions. At least one task can be established which specifies a group of related activities in the user interface. Finally, a test case can be implemented with the established task and at least one verification point.

In a preferred aspect of the method of the invention, the test case can be inherited from a super helper class based upon a base testing class in the functional testing tool. The coding step can include identifying ones of the methods having common functionality for different ones of the individual elements. The identified methods can be abstracted into an abstracted method. Subsequently, the abstracted method can be utilized in the grouping step in lieu of the identified methods. Additionally, the abstracted method can be disposed in the super helper class.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of a software testing system which has been configured in a preferred aspect of the present invention;

FIGS. 2A and 2B, taken together, are a block diagram illustrating an object-oriented architecture for the system of FIG. 1; and,

FIG. 3 is a flow chart illustrating an object-oriented process for generating an application test script in the system of FIG. 1.

### DETAILED DESCRIPTION OF THE PREFERRED EMBODIMENTS

The present invention is a method, system and apparatus for implementing an object-oriented approach to automated software testing. In accordance with the present invention, an object-oriented software testing system can include program logic for performing user interface interactions in an application under test. The system further can include program logic configured to produce object instances of action types logically grouping user interface interactions through different ones of the methods. The system yet further can include action type tasks defining groups of related activities, such as the tasks required to complete a user interface form. Finally, the system can include test cases which implement tasks and can include verification points.

In a method of the invention, methods can be defined for selected ones of the user interface elements in the application user interface under test. The methods can be defined through a record-and-playback of interactions with the selected user interface elements. Common interactions can be abstracted to produce a generalized method for structurally similar methods. Actions can be defined as combinations of the methods and tasks can be defined as combinations of the actions in implementing a test case for the application under test. The tasks can be incorporated in a test script. The test script can be defined as an implementation of a super-helper class which can extend the default class for the test script in addition to incorporating commonly used methods.

Important advantages can be achieved through the operation of the method, system and apparatus described herein. In this regard, the object-oriented structure of the system, including the defined methods, actions and tasks, can facilitate the reusability of the methods, actions and tasks in testing variants of the application under test without requiring the generation of completely new test scripts. Moreover, incremental changes in the underlying user interface will not necessitate large scale modifications to the test script. Finally, the inclusion of commonly-used methods in a super-helper class can enable multiple test scripts to utilize the commonly-used methods without requiring an exhaustive re-writing of test script functionality for each test case.

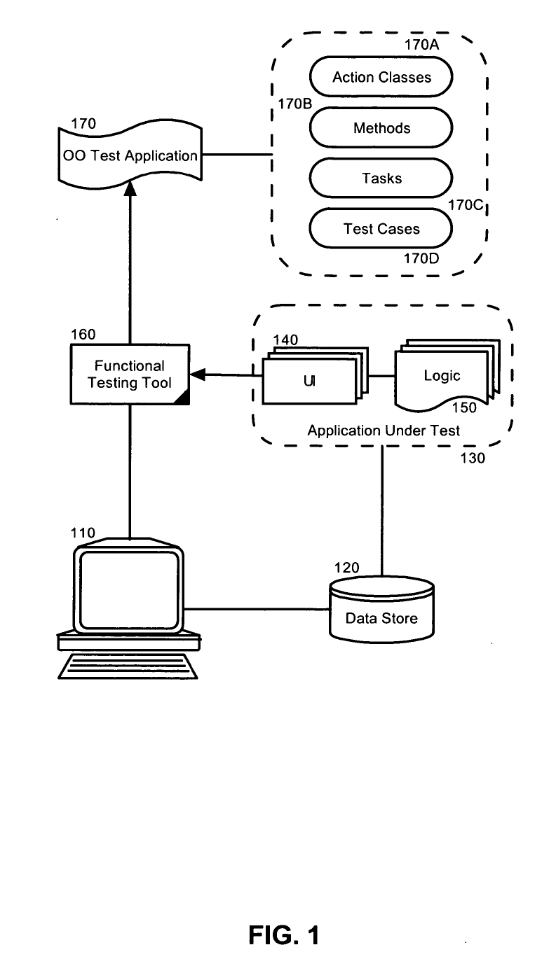

In further illustration of foregoing inventive arrangements, FIG. 1 is a schematic illustration of a software testing system which has been configured in a preferred aspect of the present invention. The system of the present invention can include a computing device 110 having a data store 120. A functional testing tool 160 can be coupled to the computing device 110 and configured to generate an object-oriented test application 170 for an application under test 130 disposed in the data store 120. Notably, the application under test 130 can include both application logic 150 and a user interface 140. In the context of a network distributable application, the user interface 140 can include one or more user interface “pages”, for example static Web pages, active server pages, Java™ server pages, and the like. Furthermore, the pages can include one or more defined forms as is well-known in the art.

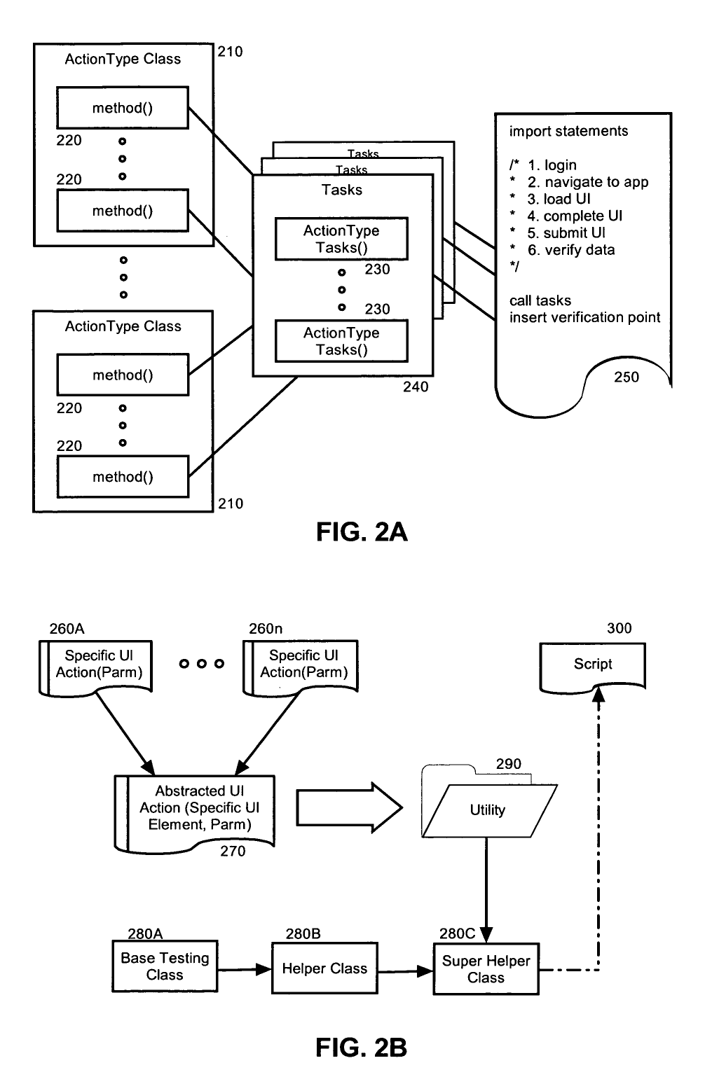

The object-oriented test application 170 can include an object-oriented test architecture of action classes 170A having one or more methods 170B, one or more tasks 170C formed through a grouping of the action classes 170A, and one or more test cases 170D combining the tasks 170C and also verification points (not shown). FIGS. 2A and 2B, taken together, are a block diagram illustrating the object-oriented architecture for the system of FIG. 1. Firstly referring to FIG. 2A, the architecture can include one or more action type classes 210 combining selected methods 220. Each method 220 can define a user interface interaction, such as the clicking of a button, or the setting of a test value. The action type classes 210 can logically group user interface interactions, such as a set of navigation buttons used repeatedly through the pages of an application under test.

Notably, the architecture can include one or more tasks 240, each task defining a group of related activities, such as the tasks required to complete a form in a page of the user interface of the application under test. Each related activity can be specified in the form of an action type task 230. Finally, one or more test cases can be defined in a test script 250 (only one test script illustrated for the sake of illustrative simplicity). Each test case in a script 250 can implement tasks and optionally can include one or more verification points. In an exemplary test case, shown in FIG. 2A, the tasks can include a login process can be followed by the navigation to the application under test. A user interface for the application under test can be loaded and the interface elements of the user interface can be completed, for instance where the interface elements are grouped in a form. Once completed, the form can be submitted and, finally, the data provided through the user interface elements can be verified.

Referring now to FIG. 2B, the script 300 can be derived from a super helper class 280C, which can be derived from a base testing class 280A such as the “RationalTestScript” base testing class of the Rational XDE Tester functional testing product. In a preferred aspect of the invention, an additional helper class 280B can be interposed in the inheritance chain between the base testing class 280A and the super helper class 280C. While the base testing class 280A can be provide the rudimentary functionality of automated testing, the helper class 280B can extend the base testing class 280A, suitable for implementation in a test script. The super helper class 280C can provide a further abstraction of both the helper class 280B and the base testing class 280A. Importantly, the super helper class 280C can incorporate commonly used methods from a utility class 290 such that all scripts can access the functionality of the methods in the utility class 290.

The utility class 290 can include a set of abstracted methods 270 defining abstracted interactions with the elements of the user interface of the application under test. Specifically, it will be recognized by the skilled artisan that different methods can include similar functionality for different user interface elements. For instance, a string can be established within a text field and within a text area by first selecting the field or area, and subsequently by inserting the string into the selected field or area. Accordingly, specific user interface action methods 260A, 260B can be abstracted to one user interface action 270. The abstracted methods 270, in turn, can be included within the utility class 290.

The utility class 290 can be organized within a utility folder storage area of the functional testing tool environment. The utility folder can include utility methods for particular operations, such as operations on files or bitmaps, as well as the super helper class 280C. The utility methods generally can be static in nature such that the utility methods can be called without first having created an instance of the class holding the methods. In addition to the utility folder, a widgets folder (not shown) can be defined in the storage area of the functional testing tool environment. The widgets folder can include methods for manipulating controls in an application under test such as checkboxes, list boxes and text fields. These methods can wrap functionality that be difficult to code directly into an abstracted form more suitable for repeated use.

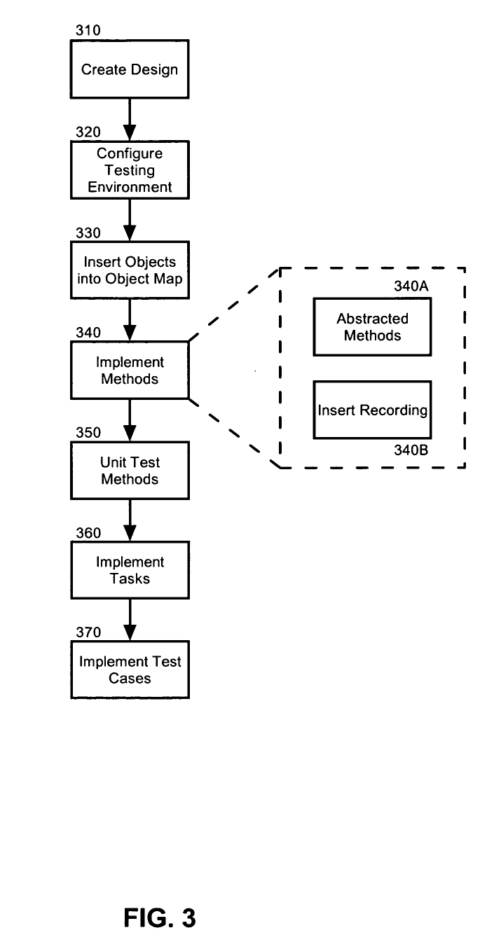

The object-oriented test architecture of the present invention can be utilized in a process for generating an application test script. To that end, FIG. 3 is a flow chart illustrating an object-oriented process for generating an application test script in the system of FIG. 1. Beginning in block 310, a design document can be generated in a functional testing tool, such as within the Rational XDE Tester functional testing tool. The design document can contain the action classes, methods, tasks and test cases of the architecture of the present invention as described in FIGS. 2A and 2B. The methods can define a user interface interaction such as getting or setting a text field, clicking a button, link or menu item, selecting a list item element in a list box, toggling a check box, or expanding or collapsing a tree, to name a few.

Preferably, an action class can be created for each user interface screen or page. To promote code reuse, though, where a portion of the page, such as a panel of buttons, appears repeatedly through the user interface screens of an application under test, however, it can be preferred to define a separate action class that addresses the repeating group of objects. In block 320, the testing environment can be configured in preparation of implementing the methods defined in block 310. To that end, a data store for the project can be created for the project in which test assets such as scripts, object maps, verification point base line files and script templates can be stored. Additionally, a local directory structure can be generated. The directory structure can include a root directory followed by a projects folder and an exports folder.

Each new project can include a suitably named directory in both the projects folder and the exports folder. The new project directory further can include respective folders for each of actions, tasks, test cases, and utilities. Notably, the actions folder can include the classes and methods for the screens in the application under test. For purposes of reusability and maintenance, subfolders can be added to the actions folder to represent a logical organization of the actions to be tested. For example, different ones of the subfolders can include actions that are common among several screens. By placing the common actions in a subfolder, the actions can be more readily exported to different testing teams.

In block 330, objects can be inserted into an object map. In this regard, when recording a script, a test object map can be generated by the object oriented test application development environment. Alternatively, a shared map can be utilized for the application under test. Each script can be associated with a test object map file. In either case, in block 340, empty methods can be defined within the script and subsequently implemented. The implementation of the methods can include the manual addition of procedural code for interacting with user interface elements in a screen (not shown), the automated insertion of recorded code in block 340B, and the generation of abstracted methods in block 340A as discussed in reference to FIG. 2A. In the case of the abstracted methods, the abstracted methods can be added to the utility class within the utility project folder created in block 320. Finally, the super helper class can be created as an extension of the base testing class in which the commonly used methods can be added.

In block 350 the implemented methods can be unit tested to confirm that the methods execute as designed. In block 360, the tasks can be implemented based upon the defined actions. Preferably, one task class can be created for each action subfolder. Specifically, an empty task script can be generated in the tasks subfolder and members can be added to the empty task script for each class in the action subfolder. Finally, in block 370, the test cases can be implemented as a sequence of actions with verification points. Specifically, objects can be created for the tasks and utilities and the tasks can be called. After calling the tasks, a verification point can be established to compare the result of the tasks with an expected result.

The present invention can be realized in hardware, software, or a combination of hardware and software. An implementation of the method and system of the present invention can be realized in a centralized fashion in one computer system, or in a distributed fashion where different elements are spread across several interconnected computer systems. Any kind of computer system, or other apparatus adapted for carrying out the methods described herein, is suited to perform the functions described herein.

A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which, when loaded in a computer system is able to carry out these methods.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. Significantly, this invention can be embodied in other specific forms without departing from the spirit or essential attributes thereof, and accordingly, reference should be had to the following claims, rather than to the foregoing specification, as indicating the scope of the invention.

1. A functional testing tool comprising a configuration for producing:
a plurality of methods defining interactions with individual elements in a user interface to an application under test;
a plurality of defined actions grouping selected ones of said methods which are used repeatedly within screens of said application under test;
at least one task defining a group of related activities in said user interface; and,
a test case implementing said at least one task with at least one verification point.

2. The functional testing tool of claim 1, further comprises a super helper class from which said test case is derived.

3. The functional testing tool of claim 1, wherein said methods comprise:
individual methods directed to interactions with specific user interface elements; and,
abstracted methods directed to generalized interactions with comparable user interface elements.

4. The functional testing tool of claim 1, wherein said abstracted methods are disposed within a super helper class from which said test case is derived.

5. A method for generating an object oriented test script in a functional testing tool, the method comprising the steps of:
coding a plurality of methods specifying interactions with individual elements in a user interface to an application under test;
grouping selected ones of said methods which are used repeatedly within screens of said application under test into a plurality of defined actions;
establishing at least one task specifying a group of related activities in said user interface; and,
implementing a test case with said at least one established task and at least one verification point.

6. The method of claim 5, wherein said coding step comprises the steps of:
identifying ones of said methods having common functionality for different ones of said individual elements;
abstracting said identified methods into an abstracted method;
and utilizing said abstracted method in said grouping step in lieu of said identified methods.

7. The method of claim 6, further comprising the step of disposing said abstracted method in a super helper class based upon a base testing class in the functional testing tool.

8. The method of claim 5, wherein said step of implementing said test case further comprises the step of inheriting said test case from a super helper class based upon a base testing class in the functional testing tool.

9. The method of claim 5, further comprising the step of configuring the functional testing tool to include a project directory for said test case, said project directory comprising at least an actions folder and a utility folder.

10. The method of claim 5, further comprising the step of inserting objects into an object map in the functional testing tool before implementing said test case.

11. The method of claim 5, further comprising the step of unit testing said methods.

12. A machine readable storage having stored thereon a computer program for generating an object oriented test script in a functional testing tool, the computer program comprising a routine set of instructions which when executed by a machine causes the machine to perform the steps of:
coding a plurality of methods specifying interactions with individual elements in a user interface to an application under test;
grouping selected ones of said methods which are used repeatedly within screens of said application under test into a plurality of defined actions;
establishing at least one task specifying a group of related activities in said user interface; and,
implementing a test case with said at least one established task and at least one verification point.

13. The machine readable storage of claim 12, wherein said coding step comprises the steps of:
identifying ones of said methods having common functionality for different ones of said individual elements;
abstracting said identified methods into an abstracted method;
and utilizing said abstracted method in said grouping step in lieu of said identified methods.

14. The machine readable storage of claim 13, wherein said computer program further comprises a routine set of instructions for causing the machine to perform the step of disposing said abstracted method in a super helper class based upon a base testing class in the functional testing tool.

15. The machine readable storage of claim 12, wherein said step of implementing said test case further comprises the step of inheriting said test case from a super helper class based upon a base testing class in the functional testing tool

16. The machine readable storage of claim 12, wherein said computer program further comprises a routine set of instructions for causing the machine to perform the step of configuring the functional testing tool to include a project directory for said test case, said project directory comprising at least an actions folder and a utility folder.

17. The machine readable storage of claim 12, wherein said computer program further comprises a routine set of instructions for causing the machine to perform the step of inserting objects into an object map in the functional testing tool before implementing said test case.

18. The machine readable storage of claim 12, wherein said computer program further comprises a routine set of instructions for causing the machine to perform the step of unit testing said methods.
